(19) United States
(12) Patent Application Publication
(10) Pub. No.: US 2006/0208209 A1
(43) Pub. Date: Sep. 21, 2006

(54) Oil-hydraulic type automatic shutoff valve water-saving structure

(75) Inventor: Ching-Hsiang Liao, Chang-Hua Hsien (TW)

Correspondence Address: TROXELL LAW OFFICE PLLC, SUITE 1404, 5205 LEESBURG PIKE, FALLS CHURCH, VA, 22041, US

(73) Assignee: Liyih Make Co., Ltd.

(21) Appl. No.: 11/143,444

(22) Filed: Jun. 3, 2005

(30) Foreign Application Priority Data
Mar. 16, 2005 (TW) 094204051

(51) Int. Cl. F16K 31/12

(52) U.S. Cl. 251/48

(57) ABSTRACT

An oil-hydraulic type automatic shutoff valve water-saving structure comprises a valve housing having a separation portion disposed therein to divide a water inlet tube, a water outlet port, and a valve chamber thereby and form a water-collecting space, a preset channel, and a water outlet channel respectively at the interior of the valve housing therein with an opening defined by a stop seat disposed in vertical alignment with one end of the separation portion thereof. Into the valve chamber of the valve housing thereof is mounted an oil-hydraulic type automatic shutoff valve composed of an outer cap, a first central shaft, an inner positioning block, a small spring, a retaining block, a big spring, a second central shaft, a water inlet valve and a regulating pin. Via the aforementioned structure, water flow accommodated at the water-collecting space therein can be individually separated from an oil storage portion of the automatic shutoff valve, precisely preventing the automatic shutoff valve from soaking in the water flow and causing the problem of water leakage into the outer cap thereof, and efficiently maintaining the hydraulic pressure and the lubrication of the oil accommodated at the oil storage portion therein to facilitate a smooth and accurate push operation of the present invention thereof.

### BACKGROUND OF THE INVENTION

The present invention is related to an oil-hydraulic type automatic shutoff valve water-saving structure, including a valve housing having a separation portion disposed therein to divide a water inlet tube, a water outlet port, and a valve chamber thereby and form a water-collecting space, a preset channel, and a water outlet channel respectively at the interior of the valve housing therein so that when an oil-hydraulic type automatic shutoff valve is mounted into the valve chamber thereof, water flow accommodated at the water-collecting space therein can be individually separated from an oil storage portion of the automatic shutoff valve, precisely preventing the automatic shutoff valve from soaking in the water flow and causing the problem of water leakage into an outer cap thereof, and efficiently maintaining the hydraulic pressure and the lubrication of the oil accommodated at the oil storage portion therein to facilitate a smooth and accurate push operation of the present invention thereof and prolong the using life time thereof.

A conventional oil-hydraulic type automatic shutoff valve as shown in the Taiwan Patent No. 471585 (referring to the attached patent document with the application No. 89210319) is characterized by the design of an automatic shutoff valve 4 completely accommodated into a valve chamber 32 of a valve housing 3 and directly immersed in water flow, which over long time of application can make water sealing rings 414, 4771, 4772 mounted therein lose their flexible property and fail to maintain accurate sealing-up effects. Thus, part of the water flow tends to leak into an outer cap 41 and mix up with oil A accommodated therein, which, affecting the interior pressure and reducing the lubrication effect of the oil thereof, can lead to an awkward and difficult push operation of the conventional oil-hydraulic automatic shutoff valve thereof.

### SUMMARY OF THE PRESENT INVENTION

It is, therefore, the primary purpose of the present invention to provide an oil-hydraulic type automatic shutoff valve water-saving structure, including a valve housing having a separation portion disposed therein to divide a water inlet tube, a water outlet port, and a valve chamber thereby and form a water-collecting space, a preset channel, and a water outlet channel respectively at the interior of the valve housing therein so that when an oil-hydraulic type automatic shutoff valve is mounted into the valve chamber thereof, water flow accommodated at the water-collecting space therein can be individually separated from an oil storage portion of the automatic shutoff valve, precisely preventing the automatic shutoff valve from soaking in the water flow and causing the problem of water leakage into an outer cap thereof, and efficiently maintaining the hydraulic pressure and the lubrication of the oil accommodated at the oil storage portion therein to facilitate a smooth and accurate push operation of the present invention thereof and extend the using life time thereof.

It is, therefore, the second purpose of the present invention to provide an oil-hydraulic type automatic shutoff valve water-saving structure wherein via an adjusting cylinder of a second central shaft, a cavity of a first central shaft, and a cylindrical channel of a pressure valve that are reciprocally communicated for the accommodation of a regulating pin with a tapered regulating needle therein, the regulating pin can be speedily and accurately adjusted to modify the distance between the tapered regulating needle and a thru-hole section of the second central shaft, permitting easy and precise regulation of the automatic shutoff valve to control the time-length and amount of water discharge according to the need of a user to achieve the best using state and save water resource thereby.

### BRIEF DESCRIPTION OF THE DRAWINGS

FIG. 1 is an exploded perspective view of the present invention.

FIG. 2 is an assembled cross sectional view of the present invention.

FIG. 3 is an assembled and partially cross sectional view of the present invention.

FIG. 4 is a diagram showing a regulation of the present invention to adjust the amount of water discharge thereof.

### DETAILED DESCRIPTION OF THE PREFERRED EMBODIMENTS

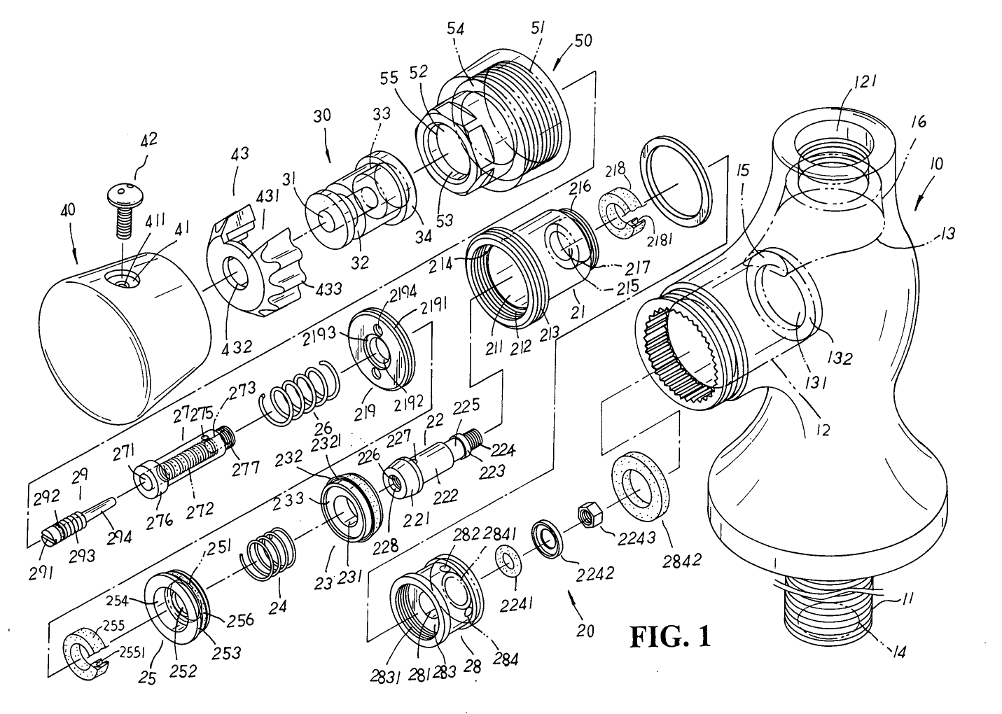

Please refer to FIG. 1 showing an exploded perspective view of the present invention. The present invention is related to an oil-hydraulic type automatic shutoff valve water-saving structure, comprising a valve housing 10, an automatic shutoff valve 20, a pressure valve 30, a press head 40, and a fixing connector 50. The valve housing 10 has a water inlet tube 11 and a water outlet port 121 respectively disposed at the bottom and top ends thereon, a valve chamber 12 extending transversely at one lateral side thereon, and a separation portion 13 disposed at a predetermined position of the interior therein wherein the separation portion 13 is made in a reversed L-shape, and both ends of which are respectively connected to the inner wall at one side of the valve chamber 12 and to the inner wall of the valve housing 10 thereof so as to divide the water inlet tube 11, the water outlet port 121, and the valve chamber 12 thereby and form a water-collecting space 14, a preset channel 15, and a water outlet channel 16 respectively at the interior of the valve housing 10 therein. An opening 131 defined by a stop seat 132 is disposed in vertical alignment with one end of the separation portion 13 thereof. The automatic shutoff valve 20 is composed of an outer cap 21, a first central shaft 22, and an inner positioning block 23, a small spring 24, a retaining block 25, a big spring 26, a second central shaft 27, a water inlet valve 28 and a regulating pin 29. The outer cap 21 is made in a hollow tubular shape with a cylindrical chamber 211 formed therein wherein a set of inner and outer locking sections 212, 213 are respectively provided defining the opening edge of the cylindrical chamber 211 thereon with a stepwise limiting flange 214 appropriately extending at the inner side therein, and a pivoting hole 215 of a smaller diameter is disposed at the bottom of the cylindrical chamber 211 thereof with an annular groove 217 defined by an external threaded end 216 protruding outwards in communication with the pivoting hole 215 thereof. A stop ring 218 defined by an indented recess 2181 therein is mounted to the annular groove 217 of the outer cap 21, and a sealing cover 219 having an external threads 2191 and a central thru-hole 2192 disposed thereon is reciprocally secured to the inner locking section 212 thereof. The sealing cover 219 also has a stepwise retaining seat 2193 indented at one side of the central thru-hole 2192 for the accommodation of the big spring 26 therein, and a pair of tapered tooling recesses 2194 symmetrically indented at the corresponding side surface thereon. The first central shaft 22 is equipped with a conic tapered stop head 221 extending at one end thereon, after which is sequentially disposed in a circular stepwise manner a movement rod 222, a positioning ring 223, and an outer threaded portion 224 that is reciprocally matched with a sealing ring 2241, a washer 2242 and a screw nut 2243 respectively. A water inlet annular groove 225 is indented between the movement rod 222 and the positioning ring 223 thereof, and a cavity 228 having an inner threaded portion 226 and a set of apertures 227 defining therein is disposed at the inner side of the conic tapered stop head 221 therein. The inner positioning block 23 has a conic tapered engaging hole 231 disposed therein, a conic positioning ring 232 with a recessed groove 2321 annularly defining thereon to be mounted at the outer periphery thereon, and a positioning seat 233 indented at one side surface thereon correspondingly matched to a retaining seat 251 of the retaining block 25 thereof for the clamping accommodation of both ends of the small spring 24 thereby. The retaining block 25 has a retaining thru-hole 252 disposed at the center of the retaining seat 251 thereon, a stepwise retaining flange 253 extending at the other side thereof, and a sleeve groove 254 disposed at the center of the retaining flange 253 therein to communicate with the retaining thru-hole 252 thereby for the accommodation therein of a stop hoop 255 having an insert recess 2551 cut thereon. And, a sealing hoop 256 is mounted at the external middle section of the retaining block 25 thereon. The second central shaft 27 has an adjusting cylinder 271 disposed at the center therein, an internally threaded portion 272 defining the middle section of the adjusting cylinder 271 thereon, a thru-hole section 273 of a smaller diameter extending at one end of the adjusting cylinder 271, and a pair of orifices 275 symmetrically disposed at both lateral side walls adjacent to the thru-hole section 273 thereon. And a stepwise abutting flange 276 and a fixing end 277 are respectively disposed at both ends of the second central shaft 27 thereof. The water inlet valve 28 has a water flow channel 281 disposed at the center therein in communication with a plurality of water outlets 282 annularly arranged at the outer periphery thereon. A first connecting seat 283 of an appropriate depth with internal threads 2831 defining thereon is indented at one end of the water inlet valve 28, and a second connecting seat 284 having a protrusive ring 2841 extending thereon and a water sealing packing 2842 mounted thereto is disposed at the other end thereof. The regulating pin 29 has a tool regulating groove 291 defining one end surface thereon, a sealing O-ring 292 mounted thereon, an outer threaded portion 293 extending further at one side thereof, and a tapered regulating needle 294 protruding at the other end thereof. The pressure valve 30 is equipped with a cylindrical channel 31 extending at the center therein, an annular locating groove 32 appropriately defining the outer periphery thereon, a receiving groove 33 disposed at the other end therein in communication with the cylindrical channel 31 thereof, and a protrusive locating block 34 extending at one end edge thereon. The press head 40 has a positioning insert block 41 with a screw hole 411 disposed at one inner sidewall thereon for the fixing location of a screw bolt 42 therewith, and an actuating cap 43 having an insert slot 431 and an engaging thru-hole 432 to be reciprocally matched with the positioning insert block 41 thereby. At the inner/outer peripheries of the actuating cap 43 thereof are annularly disposed a plurality of resilient ribs 433 respectively matched to the inner diameter of the press head 40 and the outer diameter of the pressure valve 30 therewith. The fixing connector 50 is made in a hollow tubular shape, within which an inner threaded end 51, an accommodating cavity 52 and a limiting pivot hole 53 of different diameters are sequentially disposed in a stepwise manner to define a set of first and second limiting seats 54, 55 thereby.

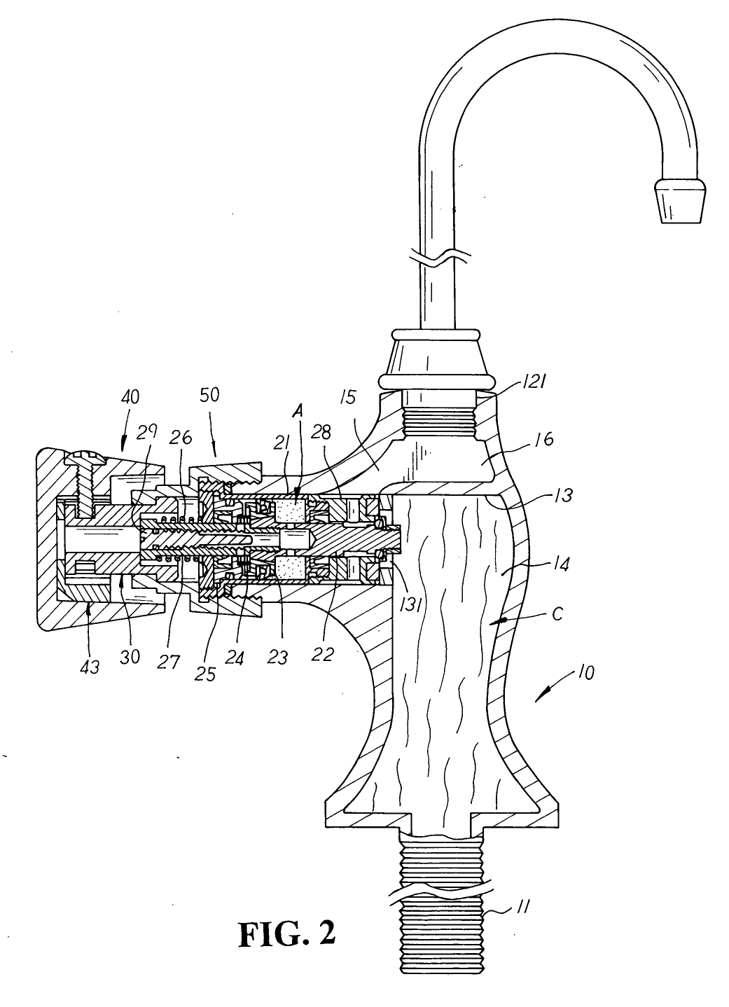

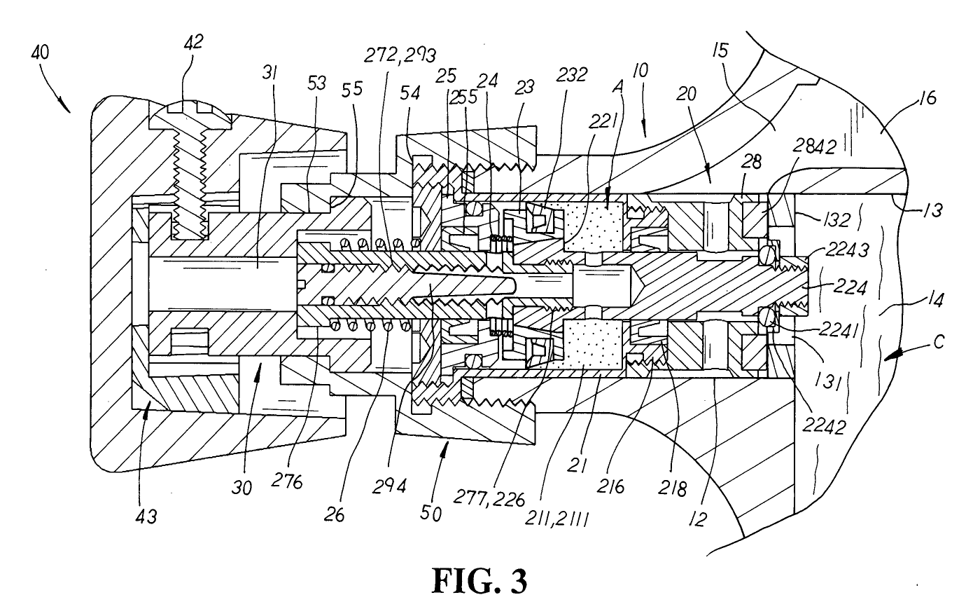

Please refer to FIGS. 2 to 3 inclusive. In assembly, the first central shaft 22 is guided through the cylindrical chamber 211 of the outer cap 21 to come out through the pivoting hole 215 till the conic tapered stop head 221 thereof is abutted against the bottom section of the cylindrical chamber 211 thereof. The inner positioning block 23 is accommodated into the cylindrical chamber 211 till the conic tapered engaging hole 231 is reciprocally mounted to the conic tapered stop head 221 of the first central shaft 22 to form a guide-push effect thereby. Then, the small spring 24 and the retaining block 25 are sequentially guided into the cylindrical chamber 211 till the retaining flange 253 thereof is abutted against the limiting flange 214 thereof, permitting the small spring 24 to be resiliently sandwiched and supported at the retaining seat 251 of the retaining block 25 and the positioning seat 233 of the inner positioning block 23 there-between. And, processing tools are applied to the tooling recesses 2194 of the sealing cover 219 so as to fixedly secure the external threads 2191 to the inner locking section 212 of the outer cap 21 thereby. The big spring 26 is then accommodated into the retaining seat 2193 of the sealing cover 219, and the second central shaft 27 is sequentially threaded through the central thru-hole 2192 of the sealing cover 219, the retaining thru-hole 252 of the retaining block 25, and the small spring 24 to accommodate into the cylindrical chamber 211 and compress the big spring 26 till the fixing end 277 thereof is securely locked to the inner threaded portion 226 of the first central shaft 22. Meanwhile, the abutting flange 276 of the second central shaft 27 is resiliently supported by the big spring 26, which will synchronically pull at the first central shaft 22 and the inner positioning block 23 to compress the small spring 24 closely abutting against the retaining block 25 thereby. Then, the conic positioning ring 232 and the sealing hoop 256 thereof are respectively abutted tight against the inner wall at the upper section of the cylindrical chamber 211 thereof. And, the stop ring 218 is simultaneously accommodated close into the annular groove 217 and mounted to the movement rod 222 thereof so as to seal off the pivoting hole 215 of the outer cap 21 thereby, permitting the bottom section defined by the inner positioning block 23 and the cylindrical chamber 211 thereof to form an oil storage portion 2111 into which an appropriate amount of oil A can be injected via the adjusting cylinder 271 of the second central shaft 27 thereby. The oil A injected via the adjusting cylinder 271 thereof will flow through the cavity 228 of the first central shaft 22 and enter the oil storage portion 2111 via the apertures 227 to accommodate therein. The regulating pin 29 is then located into the adjusting cylinder 271 of the second central shaft 27 therein with the sealing O-ring 292 thereof closely abutted against the inner wall thereof so as to completely seal up the cylindrical chamber 211 of the outer cap 21 thereby. A tool B is applied to the tool regulating groove 291 to lock the outer threaded portion 293 of the regulating pin 29 to an appropriate position of the internally threaded portion 272 of the second central shaft 27 till the regulating needle 294 thereof extends precisely into the thru-hole section 273 of the second central shaft 27 so as to generate an appropriate oil pressure at the interior thereof. Then, the internal threads 2831 of the water inlet valve 28 is fixedly secured to the external threaded end 216 of the outer cap 21 to form a preset gap with the first central shaft 22 in a space defined by the water inlet annular groove 225, the positioning ring 223, and the water flow channel 281 thereof. The stop ring 218 accommodated at the annular groove 217 of the outer cap 27 therein will be located at the first connecting seat 283 of the water inlet valve 28 corresponding to the water flow channel 281 thereof. The sealing ring 2241 and the washer 2242 are sequentially led and mounted to the outer threaded portion 224 of the first central shaft 22 and fixedly secured thereto via the screw nut 2243, permitting the sealing ring 2241 to closely abut against the protrusive ring 2841 and the outer threaded portion 224 so as to seal off the water flow channel 281 thereby to complete the assembly of the oil-hydraulic automatic shutoff valve 20 thereof. Then, the pressure valve 30 is guided through the limiting pivot hole 53 of the fixing connector 50 till the locating block 34 is abutted against the second limiting seat 55 thereof, and the inner threaded end 51 of the fixing connector 50 is reciprocally screwed up to the outer locking section 213 of the outer cap 21 till the first limiting seat 54 is abutted against the end edge of the outer cap 21 thereof, permitting the abutting flange 276 of the second central shaft 27 and the big spring 26 to locate at the receiving groove 33 of the pressure valve 30 and the accommodating cavity 52 of the fixing connector 50 therein. The actuating cap 43 and the press head 40 are sequentially mounted to the pressure valve 30, permitting the positioning insert block 41 to reciprocally engage with the insert slot 431 and correspondingly match to the annular locating groove 32 of the pressure valve 30 thereby. The screw bolt 42 is applied to abut tight against the annular locating groove 32 and stably located therein so as to prevent the press head 40 from coming off from the automatic shutoff valve 20 thereof, and the tool regulating groove 291 of the regulating pin 29 is precisely aligned to match with the cylindrical channel 31 of the pressure valve 30 and the engaging thru-hole 432 of the actuating cap 43 thereof. The automatic shutoff valve 20 is then located into the valve chamber 12 of the valve housing 10 till the press head 40 is reciprocally secured to the valve chamber 12 thereof. Meanwhile, the water sealing packing 2842 is closely abutted against the stop seat 132 of the separation portion 13 to seal off the opening 131 thereby, cutting the preset channel 15 off from the water collecting channel 14 to close the discharge of water thereby. Therefore, via the water flow of the water collecting channel 16 individually separated from the oil storage portion 2111 of the automatic shutoff valve 20, the present invention can precisely refrain the automatic shutoff valve 20 from soaking constantly in the water flow as shown in the above-mentioned conventional automatic shutoff valve and avoid the risk of water leakage into the outer cap 21 thereof so as to maintain appropriate pressure and lubrication of the oil A accommodated at the oil storage portion 2111 therein and ensure a smooth and accurate push operation thereof, efficiently facilitating a durable and longer using lifetime thereof.

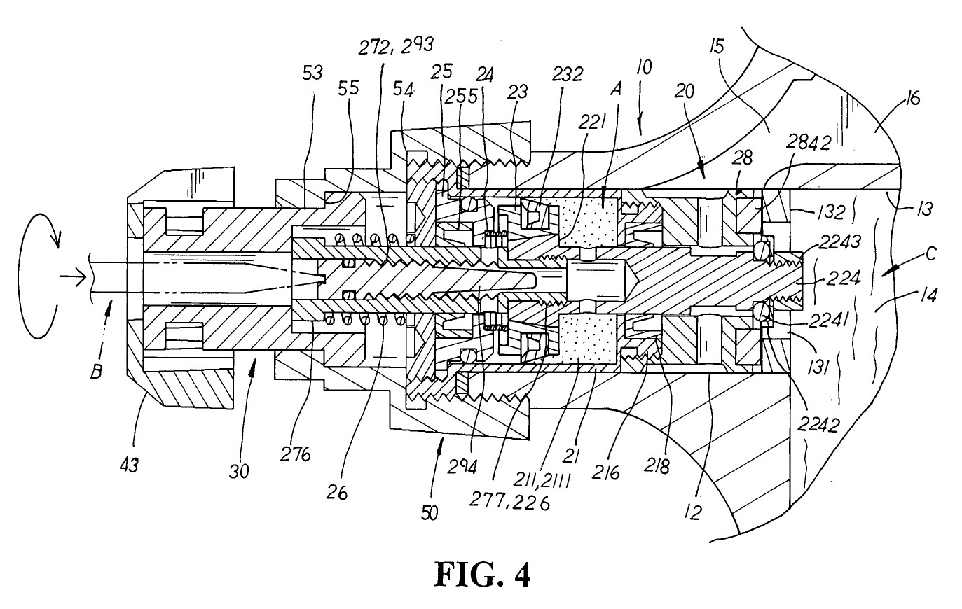

Please refer to FIG. 4 showing a regulation of the amount of water discharge of the present invention. To adjust the time-length and amount of water discharge, the press head 40 is dismantled first before a tool B is guided through the adjusting cylinder 271 of the second central shaft 27 and located into the tool regulating groove 291 of the regulating pin 29 for rotating the regulating pin 29 therewith so as to adjust the position of the regulating needle 294 ascending upwards or descending downwards thereby. Due to the conic and tapered design of the regulating needle 294, when the regulating needle 294 thereof is unscrewed to ascend upwards, the space and distance revealed between the thru-hole section 273 of the second central shaft 27 and the regulating needle 294 will be relatively enlarged and increased, permitting the oil pressure gathered inside to immediately push against the automatic shutoff valve 20 that will speedily ascend to shorten the time-length and amount of water discharge thereby. When the regulating needle 294 is screwed to descend downwards, the space and distance defined by the thru-hole section 273 and the regulating needle 294 thereof will be relatively reduced and shortened, allowing the hydraulic pressure inside the limited space thereof to slowly push against the automatic shutoff valve 20 to ascend upwards so as to prolong the time-length and increase the amount of water discharge thereby, facilitating a more accurate and speedy adjustment of the present invention so as to save both time and efforts in operation thereof.

In application, the press head 40 is pushed to sequentially move the actuating cap 43, the pressure valve 30, the second central shaft 27, the big spring 26, and the first central shaft 22 therewith, permitting the conic stop head 221 to detach from the conic engaging hole 231 of the inner positioning block 23 with a space revealed thereby for the oil A accommodated at the oil storage portion 2111 to speedily flow forwards through the revealed space thereof. While the oil A flows forwards into the newly opened space thereof, the inner positioning block 23 will be elastically brought backwards by the small spring 24. Once the press head 40 is pushed to the end, the inner positioning block 23 will be synchronically pressed to the bottom by the compressed small spring 24 thereof, permitting the conic engaging hole 231 to register again with the conic stop head 221 thereof so as to block the oil A from flowing backwards. Meanwhile, the water inlet annular groove 225 of the first central shaft 22 will extend into the water-collecting space 14 to form an annular gap with the opening 131 thereby, through which water flow C accommodated inside the water-collecting space 14 can go so as to enter the water flow channel 281 of the water inlet valve 28 and flow out there-from via each water outlet 282 to enter the valve chamber 12 thereby. Via the preset channel 15 thereof, the water flow coming into the valve chamber 12 thereof can flow through the water outlet chamber 16 to be discharged outwards through the water outlet port 121 thereof. Once the pushed press head 40 is released, the press head 40, the first and second central shafts 22, 27 will be sprung backwards by the big spring 26, and the rebounded conic stop head 221 thereof will simultaneously bring backwards the inner positioning block 23 therewith. Because the space in front of the inner positioning block 23 is filled with the oil A, the oil A is simply allowed to pass through the narrow orifices 275 of the second central shaft 27 and go along the adjusting cylinder 271 and the cavity 228 of the first central shaft 22 to slowly flow backwards into the oil storage space 2111 thereof via the apertures 227 thereof, permitting the press head 40, the first and the second central shafts 22, 27 and the inner positioning block 23 to slowly recover their former positions at an appropriate speed, and the water inlet annular groove 225 of the first central shaft 22 to withdraw backwards into the water flow channel 281 and close tightly up again by the sealing ring 2241 thereof. Meanwhile, the opening 131 will be securely sealed up by the water sealing packing 2842 so as to block the water flow inside the water-collecting space 14 to shut off the water discharge thereby. Therefore, the water flow will be accurately separated from the valve chamber 12 so that the automatic shutoff valve 20 can refrain from soaking in water flow and can keep dry when the water discharge is shutoff, efficiently preventing the gathering of water stains and the leaking of water into the outer cap 21 therein. Besides, in the state of water discharge, water pressure will be guided along the first central shaft 22 to push against the indented recess 2181 of the stop ring 218, permitting both lateral sidewalls of the indented recess 2181 affected by the pressure thereof to deform and closely abut against the inner wall of the annular groove 217 and the outer wall of the first central shaft 22 respectively so as to accurately prevent water from leaking into the outer cap 21, achieving the best using state of the present invention thereby.

What is claimed is:

1. An oil-hydraulic type automatic shutoff valve water saving structure, comprising a valve housing, an automatic shutoff valve, a pressure valve, a press head, and a fixing connector wherein the valve housing has a water inlet tube and a water outlet port respectively disposed at the bottom and top ends thereon; the present invention being characterized by that,
the valve housing having a valve chamber extending transversely at one lateral side thereon, and a separation portion disposed at a predetermined position of the interior therein to divide the water inlet tube, the water outlet port, and the valve chamber thereby and to form a water-collecting space, a preset channel, and a water outlet channel respectively at the interior of the valve housing therein; an opening defined by a stop seat being disposed in vertical alignment with one end of the separation portion thereof;
the automatic shutoff valve being composed of an outer cap, a first central shaft, an inner positioning block, a small spring, a retaining block, a big spring, a second central shaft, a water inlet valve and a regulating pin wherein,
the outer cap having a pivoting hole of a smaller diameter disposed at the bottom of a cylindrical chamber therein, an annular groove defined by an external threaded end protruding outwards in communication with the pivoting hole thereof, a stop ring defined by an indented recess mounted to the annular groove therein, and a sealing cover having a central thru-hole disposed thereon to be reciprocally matched to the outer cap therewith;
the first central shaft being equipped with a stop head extending at one end thereon, after which is sequentially disposed in a stepwise manner a movement rod, a positioning ring, and an outer threaded portion that is reciprocally matched with a sealing ring, a washer and a screw nut respectively; a water inlet annular groove being indented between the movement rod and the positioning ring thereof, and a cavity being disposed at the central inner side of the stop head therein;
the inner positioning block having an engaging hole disposed therein, and a conic positioning ring with a recessed groove annularly defining thereon to be mounted at the outer periphery thereon wherein the small spring is clamped between the inner positioning block and the retaining block thereof;
the retaining block having a retaining thru-hole disposed at the center of a retaining seat therein, a stepwise retaining flange extending at the other side of the retaining seat thereof, a sleeve groove disposed at the center of the retaining flange therein to communicate with the retaining thru-hole thereof for the accommodation therein of a stop hoop having an insert recess cut thereon, and a sealing hoop mounted at the external middle section of the retaining block thereon;
the second central shaft having an adjusting cylinder extending at the center therein, an internally threaded portion defining the middle section of the adjusting cylinder therein, a thru-hole section of a smaller diameter extending at one end of the adjusting cylinder, a pair of orifices symmetrically disposed at both lateral side walls adjacent to the thru-hole section thereof, a stepwise abutting flange extending at one end of the second central shaft to reciprocally abut against the big spring thereby, and a fixing end protruding at the other side of the second central shaft thereof;
the water inlet valve having a water flow channel extending at the center therein in communication with a plurality of water outlets annularly arranged at the outer periphery thereon; the water inlet valve being respectively engaged with the outer cap at one end, and abutted against the opening of the valve housing at the other end with a water sealing packing sandwiched there-between;
the regulating pin having a tool regulating groove defining one end surface thereon, a sealing O-ring mounted thereon, and an outer threaded portion with a tapered regulating needle sequentially extending further at the other end thereof;
the pressure valve being equipped with a cylindrical channel extending at the center therein, an annular locating groove appropriately defining the outer periphery thereon, a receiving groove disposed at the other end therein in communication with the cylindrical channel thereof, and a protrusive locating block extending at one end edge thereon;
therefore, the separation portion of the valve housing is applied to divide the water inlet tube, the water outlet port, and the valve chamber thereby and to form a water-collecting space, a preset channel, and a water outlet channel respectively at the interior of the valve housing therein so that, when the oil-hydraulic type automatic shutoff valve is mounted into the valve chamber of the valve housing thereof, water flow accommodated at the water-collecting space therein can be individually separated from an oil storage portion of the automatic shutoff valve, precisely preventing the automatic shutoff valve from soaking in the water flow and causing the problem of water leakage into the outer cap thereof, and efficiently maintaining the hydraulic pressure and the lubrication of the oil accommodated at the oil storage portion therein to facilitate a smooth and accurate push operation of the present invention thereof; besides, the adjusting cylinder of the second central shaft, the cavity of the first central shaft, and the cylindrical channel of the pressure valve are reciprocally communicated for the accommodation of the regulating pin with the tapered regulating needle therein so that the regulating pin can be speedily and accurately adjusted to modify the distance between the tapered regulating needle and the thru-hole section of the second central shaft thereof for easy and precise regulation of the automatic shutoff valve to control the time-length and amount of water discharge according to the need of a user.

2. The oil-hydraulic type automatic shutoff valve water-saving structure as claimed in claim 1 wherein the press head thereof has a positioning insert block with a screw hole disposed at one inner side wall thereon for the fixing location of a screw bolt therewith, and an actuating cap having an insert slot and an engaging thru-hole to be reciprocally matched with the positioning insert block thereof; at the inner/outer peripheries of the actuating cap thereof are annularly disposed a plurality of resilient ribs respectively matched to the inner diameter of the press head and the outer diameter of the pressure valve therewith.

3. The oil-hydraulic type automatic shutoff valve water-saving structure as claimed in claim 1 wherein the fixing connector thereof is made in a hollow tubular shape, within which an inner threaded end, an accommodating cavity and a limiting pivot hole of different diameters are sequentially disposed in a stepwise manner to define a set of first and second limiting seats thereby.

4. The oil-hydraulic type automatic shutoff valve water-saving structure as claimed in claim 1 wherein the separation portion of the valve housing is made in a reversed L-shape, and both ends of which are respectively connected to the inner wall at one side of the valve chamber and to the inner wall of the valve housing thereof.

5. The oil-hydraulic type automatic shutoff valve water-saving structure as claimed in claim 1 wherein the outer cap thereof is made in a hollow tubular shape with a cylindrical chamber formed therein, and a set of inner and outer locking sections are respectively provided defining one opening edge of the cylindrical chamber thereon with a stepwise limiting flange extending at the inner side thereof.

6. The oil-hydraulic type automatic shutoff valve water-saving structure as claimed in claim 1 wherein the sealing cover thereof is provided with external threads defining the outer periphery thereon to be reciprocally registered with the inner locking section of the outer cap thereby.

7. The oil-hydraulic type automatic shutoff valve water-saving structure as claimed in claim 1 wherein the sealing cover thereof has a stepwise retaining seat indented at one side of the central thru-hole thereon for the accommodation of the big spring therein.

8. The oil-hydraulic type automatic shutoff valve water-saving structure as claimed in claim 1 wherein the sealing cover also has a pair of tapered tooling recesses symmetrically indented at the corresponding side surface of the stepwise retaining seat thereon.

9. The oil-hydraulic type automatic shutoff valve water-saving structure as claimed in claim 1 wherein the stop head of the first central shaft thereof is made in a conic and tapered shape.

10. The oil-hydraulic type automatic shutoff valve water-saving structure as claimed in claim 1 wherein the cavity of the first central shaft is equipped with an inner threaded portion defining therein.

11. The oil-hydraulic type automatic shutoff valve water-saving structure as claimed in claim 1 wherein the engaging hole of the inner positioning block thereof is made in a conic and tapered shape.

12. The oil-hydraulic type automatic shutoff valve water-saving structure as claimed in claim 1 wherein the inner positioning block has a positioning seat indented at one side surface thereon correspondingly matched to a retaining seat of the retaining block thereof for the clamping accommodation of both ends of the small spring thereby.

13. The oil-hydraulic type automatic shutoff valve water-saving structure as claimed in claim 1 wherein at one end of the water inlet valve thereof is disposed a first connecting seat of an appropriate depth with internal threads defining thereon, and at the other end of the water inlet valve is provided with a second connecting seat having a protrusive ring extending thereon for a water sealing packing to mount thereto.
